(19) United States
(12) Patent Application Publication
(10) Pub. No.: US 2024/0406163 A1
(43) Pub. Date: Dec. 5, 2024

(54) METHOD FOR MANAGING THE LIFE CYCLE OF A SYSTEM-ON-CHIP, AND CORRESPONDING SYSTEM-ON-CHIP

(71) Applicant: STMicroelectronics International N.V., Geneva (CH)

(72) Inventors: Loic Pallardy, Rouillon (FR); Maxime Mere, Le Mans (FR); Frédéric Jouault, Trélazé (FR)

(21) Appl. No.: 18/678,831

(22) Filed: May 30, 2024

(30) Foreign Application Priority Data
May 31, 2023 (FR) 2305441

(51) Int. Cl. H04L 9/40; G06F 21/10; H04L 9/32

(52) U.S. Cl. CPC H04L 63/0823; G06F 21/101; H04L 9/3247

(57) ABSTRACT

A method for life cycle management of a system-on-chip having functions includes multi-user ownership management listing owners of the functions in a directory, and allocating rights of a function over the life cycle of the system-on-chip, according to a configuration command including identifying the function, identifying a right of ownership or access to the function, and a signature of the owner of the function.

### CROSS-REFERENCE TO RELATED APPLICATIONS

This application claims the benefit of French Patent Application No. 2305441, filed on May 31, 2023, which application is hereby incorporated herein by reference.

### TECHNICAL FIELD

Embodiments and implementations relate to the life cycle management of a system-on-chip, in particular the management of functions of the system-on-chip over the life of the product (the product being, for example, the system-on-chip or an object incorporating the system-on-chip).

### BACKGROUND

There is a demand for services that can be activated dynamically over the life of the product, such as renting for end-users, guaranteeing security in the use of functions, traceability of use, simplification of the initial configuration procedure by the original manufacturer of the product, and/or active recycling of systems-on-chip.

Conventional solutions are not typically in tune with these needs because they do not allow in particular dynamic configuration of the right holders over the life of the product whilst ensuring security against hackers or unauthorized access.

Indeed, conventionally, system-on-chip functions can be activated or deactivated by configuration at the end of the production line, typically by writing to a one-time-programmable memory, i.e., a non-volatile memory that can only be written once by the circuit manufacturer.

Other conventional systems may provide for activation or deactivation of functions over the life of a product, but require an action from a trusted authority that is external to the system, such as in a client-server function providing additional online functions to the system (client) via the external trusted authority (server).

### SUMMARY

There is therefore a need to propose systems-on-chip able to activate and deactivate functions (or functionalities or features) dynamically over the life cycle of the product, for example depending on the owner of the product, without the action of an external and centralized trusted authority, and advantageously reversibly and without a time limit. In addition, it is desirable that the security of the dynamic activation/deactivation process is guaranteed and is designed to be tamper-proof.

The implementations and embodiments defined below are proposed in this respect and allow a system-on-chip to benefit from dynamic management of function activation or deactivation (for example by management of access rights to these functions) throughout the life cycle of the system-on-chip, and not only during the production of the integrated circuit.

Thus, the implementations and embodiments defined below, by enabling dynamic configurations and reconfigurations of the system-on-chip, can provide: improved traceability of the chips; implementation of smart renting; a way of guarding against overproduction and counterfeiting; the secure provision of “new” functions to a product; a multiple ownership option; the option to transfer ownership and licenses for functions; a way of proving the ownership of the system.

According to one aspect, a method is proposed for life cycle management of a system-on-chip having functions, comprising multi-user ownership management listing owners of the functions in a directory, and comprising an allocation of rights of a function over the life cycle of the system-on-chip, according to a configuration command including identifying the function, identifying a right of ownership or access to the function, and a signature of the owner of this function.

According to one embodiment, the directory is contained in a programming script stored in a secure memory, and the configuration command is communicated in a modified version of the script, the method comprising executing the script in order to carry out the allocation of rights of the identified function.

According to one embodiment, the directory is contained in a one-time programmable memory, and the configuration command is communicated in a certificate including a data string and stored in a secure memory, the method comprising interpreting the certificate in order to carry out the allocation of rights of the identified function.

“Certificate” is understood to mean a string of certified data, for example a signed data string whose public key is contained in the directory; or for example a signed data string whose public key is contained in a signed authentication document attached to the data string, and whose public key (of the authentication document) is contained in the directory. Such an authentication document may, for example, be governed by the X.509 standard (the authentication document being distinctly named a certificate in the X.509 standard).

Finally, “certificate” is also understood to mean any other equivalent means providing a mechanism for validating (or certifying) the data string, such as validation within a blockchain system.

According to one embodiment, if the configuration command includes identifying an access right, the ownership management comprises allocating access authorizations to the identified function.

According to one embodiment, if the configuration command includes identifying the ownership right of the function to an identified user, the ownership management comprises allocating the ownership of the identified function to the identified user.

According to one embodiment, the ownership management comprises verifying that the signature of the configuration command authenticates the last known owner in the directory for the identified function.

For example, the ownership management comprises decrypting the signature of the configuration command with an encryption key of the last known owner.

According to one embodiment, the system-on-chip also includes a system authorizing and prohibiting access to functions according to the contents of a configuration register, the ownership management comprising programming the configuration register to allocate the function rights.

For example, the system able to authorize and prohibit access to functions can be implemented in a system-on-chip access rights management system, such as the resource isolation environment described in the publication FR 3103586 A1 (28/05/2021) enabling in particular dynamic management of the access rights.

According to one embodiment, the method can comprise irreversible storage of a content of the configuration register, i.e., at least part of the contents of the configuration register, if the configuration command also defines an irreversible nature of the allocation.

According to one embodiment, the allocation of function rights is performed when the system-on-chip is started up, in cooperation with the system authorizing and prohibiting access to the functions, such that all access is prohibited prior to the allocation.

According to one embodiment, the method also includes the continuous generation of a timestamp, wherein the ownership management comprises programming at a future time, determined by the timestamp, the allocation to the user of the function.

“Continuous generation of a timestamp” is understood to mean autonomous generation of temporal information of an order of magnitude in terms of date and time in the system-on-chip; for example generated by means of a continuous timestamp circuit, also called a secure timing system or secure system time or secure RTC (secure real time clock).

According to another aspect, a system-on-chip is also proposed, having functions, and comprising a life cycle management system incorporating a multi-user ownership management circuit designed to list owners of the functions in a directory, and to allocate rights of a function over the life cycle of the system-on-chip, according to a configuration command including identifying the function, identifying a right of ownership or access to the function, and a signature of the owner of this function.

According to one embodiment, the directory is contained in a programming script stored in a secure memory, and the configuration command is communicated in a modified version of the script, the ownership management circuit including a control unit designed to execute the script in order to carry out the allocation of rights of the identified function.

According to one embodiment, the directory is contained in a one-time programmable memory, and the configuration command is communicated in a certificate including a data string and stored in a secure memory, the ownership management circuit including a control unit designed to interpret the certificate in order to carry out the allocation of rights of the identified function.

According to one embodiment, the ownership management circuit is designed to allocate authorizations for access to the identified function, if the configuration command includes identifying an access right.

According to one embodiment, the ownership management circuit is designed to allocate the ownership of the identified function to the identified user, if the configuration command includes identifying the ownership right of the function to an identified user.

According to one embodiment, the ownership management circuit includes an authentication unit designed to verify that the signature of the configuration command authenticates the last known owner in the directory for the identified function.

According to one embodiment, the system-on-chip also includes a system designed to authorize and prohibit access to functions of the system-on chip according to the contents of a configuration register, the ownership management circuit being designed to program the configuration register in order to allocate the function rights.

According to one embodiment, the configuration register is able to store a content irreversibly, if the configuration command also defines an irreversible nature of the allocation.

According to one embodiment, the ownership management circuit is designed to perform the allocation of function rights when the system-on-chip is started up, in cooperation with the system designed to authorize and prohibit access to the functions of the system-on-chip such that all access is prohibited prior to the allocation.

According to one embodiment, the system-on chip also includes a secure continuous timestamp circuit, wherein the ownership management circuit is designed to program at a future time, determined by the timestamp circuit, the allocation of rights of the function.

### BRIEF DESCRIPTION OF THE DRAWINGS

Other advantages and features of the invention will become apparent upon examining the detailed description of non-limiting embodiments and implementations, and from the accompanying drawings, in which figures:

FIG. 1 illustrates an embodiment system-on-chip;

FIG. 2 illustrates a first embodiment of a method for life cycle management;

FIG. 3 illustrates a first embodiment of an ownership management circuit;

FIG. 4 illustrates a method for verification by an authentication unit;

FIG. 5 illustrates a method for implementing a script modification procedure;

FIG. 6 illustrates a second embodiment of a method for life cycle management;

FIG. 7 illustrates a the second embodiment of an ownership management circuit;

FIG. 8 illustrates another method for verification by an authentication unit;

FIG. 9 illustrates a method for implementing a configuration modification procedure;

FIG. 10 illustrates a command to change function ownership;

FIG. 11 illustrates a configuration command in which a user activates functions;

FIG. 12 illustrates a configuration command in which a user makes a current function configuration irreversible;

FIG. 13 illustrates a configuration command in which a user activates a function for a limited time; and

FIG. 14 illustrates the case of FIG. 13 after the limited activation period for the function has expired.

### DETAILED DESCRIPTION OF ILLUSTRATIVE EMBODIMENTS

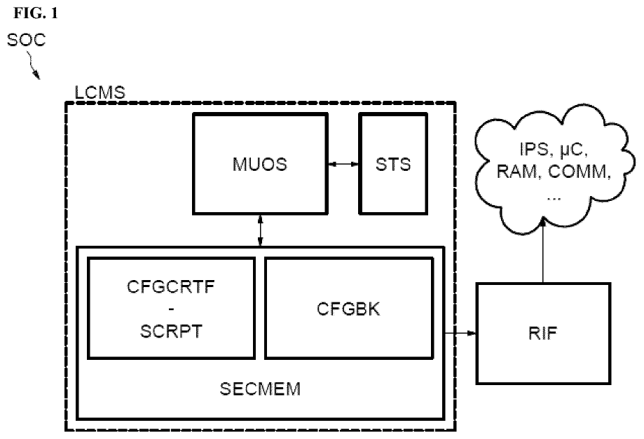

FIG. 1 illustrates an exemplary embodiment of a system-on-chip SOC, having functions, and comprising a life cycle management system LCMS able to activate or deactivate functions dynamically throughout the life of the system-on-chip SOC.

The life of the system-on-chip, which can also be called the life cycle, begins at the end of the production line, when the integrated circuit is functional and able to be configured by the manufacturer for a given market, and then includes the marketing and use of the system-on-chip, until the product is waste and potentially recycled.

The functions of the system-on-chip SOC can be implemented by specially dedicated resources IPS, such as an image sensor and an image processing or neural processing hardware accelerator, and/or by common resources such as a uC microcontroller; RAM memory, COMM communications interfaces such as “WiFi” (IEEE 802.11 group standards), “4G/5G/LTE” (ITU and 3GPP standards), “USB”, “I2C”, “SPI”, etc.; as well as other hardware or software resources.

In general, we will refer to any function that can be distinctively identified by the reference “IPS”, regardless of the means by which it is obtained.

Thus, and as will become apparent in the following description, the ability to dynamically activate or deactivate functions IPS is advantageous from this first stage of the system-on-chip SOC life cycle, diversifying the potential settings of a same production of the integrated circuit of the system SOC, for example according to different commercial ranges, whilst facilitating the manufacturer's configuration procedure and stock management.

Over the life of the system, i.e., as it is marketed and used, the ability to dynamically activate or deactivate functions IPS can enable the manufacturer or owner of the system-on-chip SOC, for example, to implement smart renting of certain functions, or to provide “new” functions for the product, as in the case of an update.

The ability to dynamically activate or deactivate functions also enables better management of owners of the system-on-chip SOC, providing in particular the possibility of multi-ownership of functions and transfer of ownership of functions, and means of proving ownership.

In addition, at the end of the life cycle of a product, the system-on-chip SOC can be actively recycled, i.e., for example be re-used with a reconfiguration adapted to the second application, here too thanks to the ability to dynamically activate or deactivate the functions.

The system-on-chip SOC advantageously includes a resource isolation system RIF able to authorize and prohibit access to the functions IPS of the system-on-chip SOC. For example, the resource isolation system RIF is part of a resource access management system as described in the publication FR 3103586 A1 (28/05/2021), which is particularly suitable for dynamic configurations depending on the applications of the system-on-chip.

For example, the resource isolation system RIF may be able to read the contents of one or more configuration register(s) CFGBK in order to configure the authorization or prohibition of access to a given resource by a given requesting device.

The configuration register(s) CFGBK can, for example, belong to the resource isolation system RIF, in which case the life cycle management system LCMS may be able to write the configuration to the configuration register(s) CFGBK.

The configuration register(s) CFGBK can, for example, belong to the life cycle management system LCMS, and be contained in a secure memory SECMEM.

The life cycle management system LCMS advantageously includes a secure memory SECMEM that can contain the configuration register CFGKB mentioned above, as well as configuration command instructions CRTF-CFG/SCRPT enabling access authorizations to functions IPS to be modified dynamically over the life of the system-on-chip.

In this respect, the life cycle management system LCMS includes a multi-user ownership management circuit MUOS designed, on the one hand, to list owners for at least certain of the functions IPS in a directory and, on the other hand, to dynamically allocate function rights IPS over the life of the system-on-chip SOC depending on a configuration command, for example via the communication interfaces COMM.

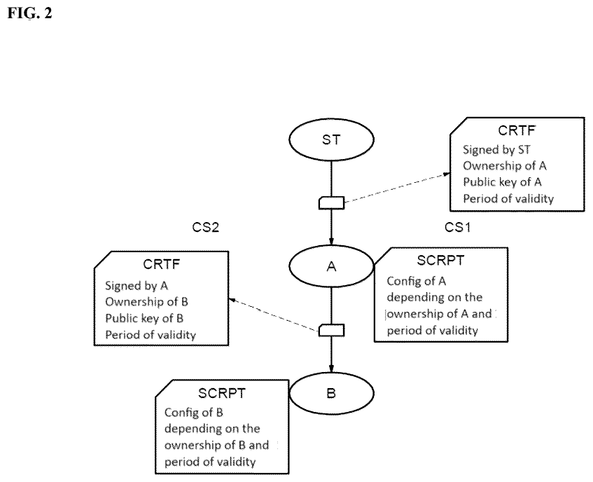

The configuration command can include at least identifying the function IPS, identifying the user and a signature of the owner of this function, and can be communicated according to the embodiments described below with reference to FIGS. 2 to 5 and FIGS. 6 to 9.

Advantageously in terms of operational security, the ownership management circuit MUOS is designed to carry out allocations of the function rights each time the system-on-chip SOC is started up, and in cooperation with the resource isolation system RIF such that all access is prohibited prior to the allocation.

In addition, the life cycle management system LCMS can include a secure continuous timestamp circuit STS such that the ownership management circuit MUOS can program its dynamic allocations of function rights at a future time, determined by the timestamp circuit STS.

Indeed, the secure continuous timestamp circuit STS is advantageously able to autonomously generate temporal information of an order of magnitude in terms of date and time in the system-on-chip, and is, for example, usually called “secure timing system” or “secure system time” or “secure RTC”.

We will now refer to FIGS. 2 to 5, showing a first embodiment and implementation related to the configuration command.

FIG. 2 shows the first embodiment for the method for life cycle management wherein the configuration commands are communicated in the form of a script SCRPT, i.e., a human-readable programming language.

This is advantageous from the point of view of the end users, who can easily configure scripts according to their needs.

On the one hand, in life cycle management, owners of various functions are listed as part of multi-user ownership management.

This means that once the system-on-chip SOC has been manufactured, the manufacturer ST is the owner of all the functions and has full rights to all functions.

The manufacturer ST could therefore, for example, stipulate that not all functions are activated by default. Activation could be carried out later for commercial reasons depending on, for example, the range offered or the type of offer.

The manufacturer ST can thus provide a user A (for example, a buyer) with information CRTF enabling the ownership of at least one function IPS to be transferred to the user A.

The information CRTF is signed by the manufacturer, and includes identifying this or these function(s) IPS, identifying the user A, for example by communicating a public key of the user A, and optionally a period of validity for this allocation.

The user A will then be able to generate a configuration command SCRPT based on the information provided by the former transferring owner.

The configuration command SCRPT includes identifying a right of ownership or access to the function.

If the configuration command includes identifying an access right, the ownership management comprises allocating access authorizations to the identified function.

The user A can thus configure the system-on-chip SOC by choosing to activate or deactivate the functions they own. The user A could then provide another user B with the system-on-chip SOC in this configuration. The user B, without knowing the key of the owner A and/or the manufacturer ST, will not be able to generate another configuration command and will not be able to modify the allocation of function rights established by the user A.

The configuration command generated by the user A can include identifying the ownership right of the function to a user B, identified in the command, so the ownership management comprises allocating the ownership to the identified user B, i.e., a transfer of ownership from the user A to the user B.

In this respect, the user A can also provide the user B with information CRTF enabling the ownership of at least one function ISP to be transferred from the user A to the user B.

Here too, the information CRTF is signed by the user A, and includes identifying the at least one function IPS, identifying the user B, for example by communicating a public key of the user B, and optionally a period of validity for this allocation.

In summary, in the first embodiment, the directory is contained in a programming script SCRPT stored, for example, in the secure memory SECMEM. The configuration command is communicated in a modified version of the script SCRPT, by the user A, B having knowledge of the information CRTF of the ownership transfer. The configuration command includes in particular the public key of the new owner A (or B) and is signed by the previous owner ST (or A).

The script is interpreted as part of ownership management, for example by a control unit CONT of the management circuit MUOS, in order to execute the allocation in practice to the identified user of the identified function.

Note that while the above example provides for the transfer of a function or feature to a single user (A or B), it is also possible to transfer a function to several users, thereby creating multiple ownership of the same function.

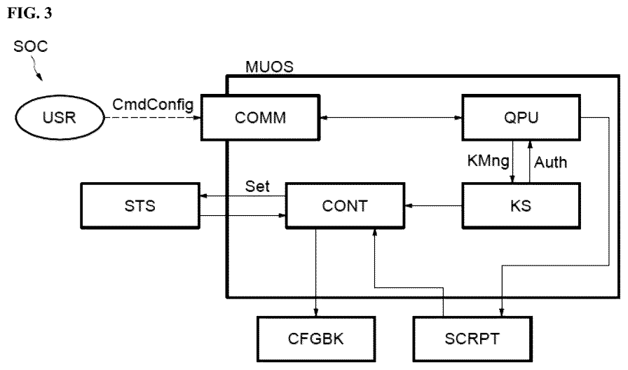

FIG. 3 shows an example of the first embodiment of the corresponding ownership management circuit MUOS, i.e., able in particular to process configuration commands communicated in the form of a script (a human-readable programming language).

The ownership management circuit MUOS is able to receive the configuration command CmdConfig from a user USR, for example by means of a communication interface COMM present in the system-on-chip SOC.

The configuration commands CmdConfig are processed by an authentication unit QPU, in particular able to manage and store encryption keys KMng in a register KS, and to authenticate Auth the signature of the configuration command CmdConfig.

The authentication unit QPU is, for example, designed to authenticate the origin of the configuration command CmdConfig by verifying that the signature of the configuration command CmdConfig matches a public key, stored in the register KS, of the last known owner for the identified function, i.e., the owner listed in the directory when the command CmdConfig is received.

The signature can be verified using conventional symmetrical or asymmetrical encryption methods, possibly combined with a command hash function.

The signature of the configuration command CmdConfig can be verified and authenticated by obtaining a fingerprint from the hash of the script, by decrypting the encrypted fingerprint of the script with the public key of the last known owner.

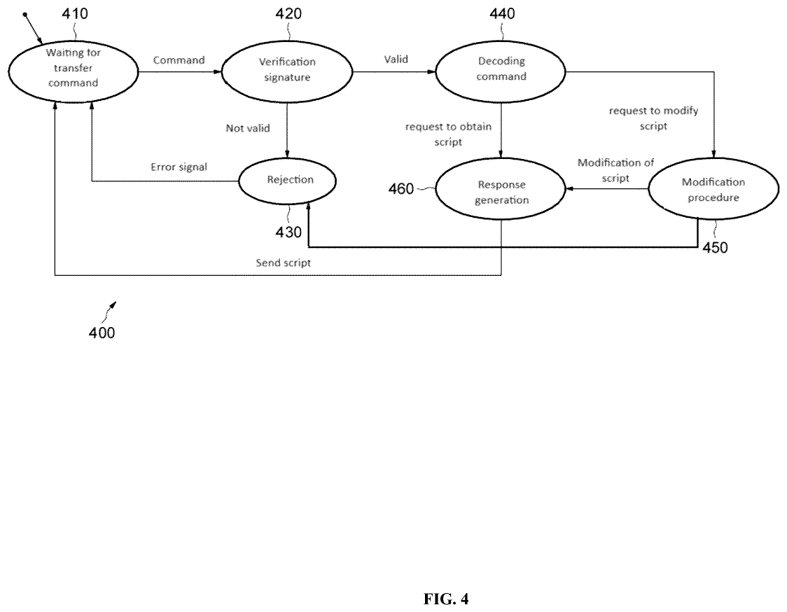

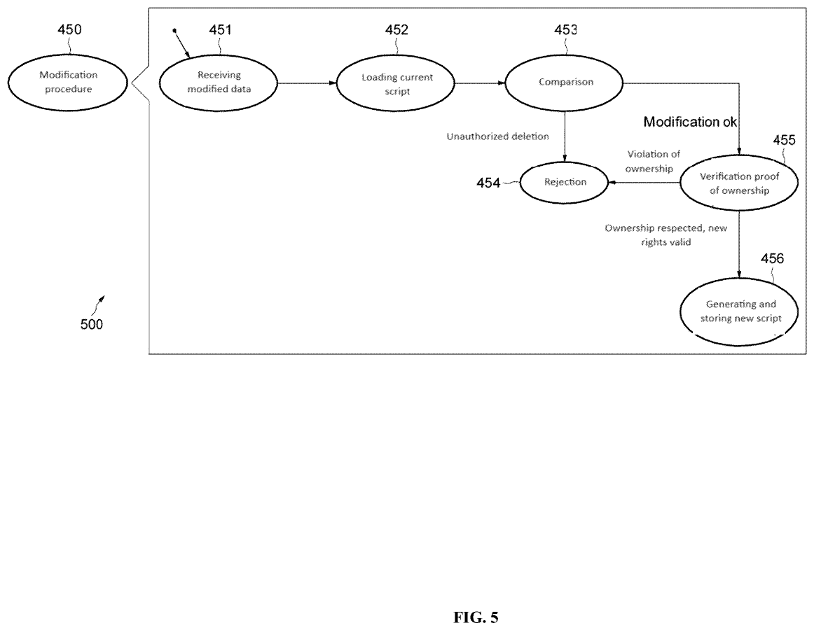

If the configuration command CmdConfig is authenticated, the script received SCRPT is saved without any encryption in the secure memory SECMEM; otherwise, the command is rejected. Reference is made in this regard to FIGS. 4 and 5 described below.

In addition, the ownership management circuit MUOS is, for example, designed to program the configuration register CFGBK, for example in a section of the secure memory SECMEM, in order to communicate the configuration of the allocation of function rights.

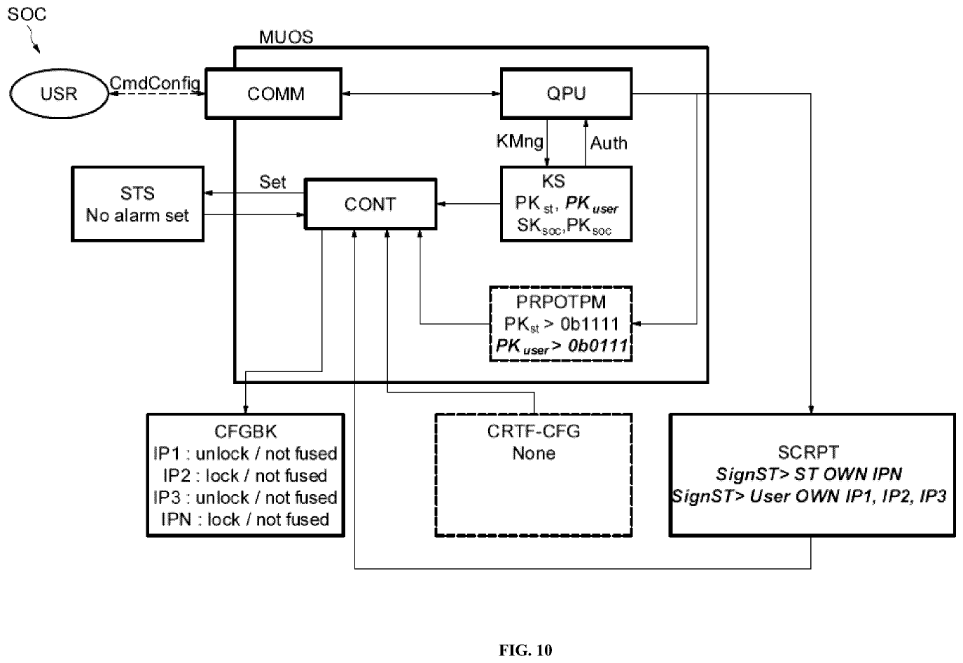

Optionally, the configuration register CFGBK may be able to store a content irreversibly, for example via a fusible mechanism FUS (see FIGS. 10-14), if the configuration command CmdConfig also defines an irreversible nature of the allocation.

FIG. 4 shows a method 400 for carrying out the verification by the authentication unit QPU.

In an initial state 410, the unit QPU is in a state waiting for the configuration command.

When a configuration command is received, a verification of the signature that it contains is carried out in step 420.

For example, the configuration command is communicated in a message containing a fingerprint of the content of the command, encrypted by a hash mechanism, and containing the signature of the command encrypted by a private key of the sender. The verification of the signature may typically include decrypting the signature with a public key associated with the sender such that the message is authenticated when the decrypted signature is identical to the fingerprint; it is then the that the signature is “valid”.

If the signature is not valid, the configuration command is ignored and rejected 430 and the unit QPU returns to the waiting state 410. An error message may be generated. A record of the rejection can be recorded in a log.

For example, the signature is not valid if the message communicating the configuration command is not signed by the owner of the identified function. The command will also be rejected in a step 454 (FIG. 5) if a user commands a modification to part of the script for which they do not have the appropriate rights.

If the signature is valid, the fingerprint of the content of the configuration command is decoded in a step 440, for example firstly decrypted by the corresponding hash mechanism so as to obtain the command without any encryption, then interpreted, i.e., decoded and executed according to the language of the script provided.

If the command requires the script to be modified, the modifications are carried out in the script in a modification procedure of the script 450, in particular able to take into account and respect the rights of the various users.

In this respect, reference is made to FIG. 5.

FIG. 5 shows an exemplary method 500 for implementing the modification procedure of the script 450.

The modification procedure of the script 450 includes a comparison 453 between the modified data received 451 and the current script (before modification 452), loaded from the memory SECMEM.

Firstly, if the differences identified in the comparison 453 include an unauthorized deletion of at least one line of script, the modification command is rejected 454.

Secondly, the proof of ownership of functions IPS whose rights are modified is verified in a step 455. For example, it is possible in this regard to verify that a transfer of ownership of a function IPS is signed by the previous owner and includes a public key of the new owner. For example, it is possible to verify that a transfer of the right to use a function IPS is modified by the owner of the function IPS.

The function IPS can be identified by an internal identifier of the system-on-chip SOC, such as a device address or “CID” compartment identifier (see the abovementioned publication).

In the event of a violation of ownership, the modification command is rejected 454.

If the ownership is respected and the new rights are valid, a new script is generated and stored in the memory SECMEM during a step 456. It should be noted that the new script does not necessarily replace the old script, which can provide a history of modifications.

Reference is made again to FIG. 4.

Following the modification procedure of the script 450, a response can be generated in a step 460 before returning to the state of waiting for a next command 410.

If the command includes a request to modify the script, then, if successful, the new modified script is sent in response 460 to the sender.

If the command includes a request to obtain the script(s), the current script is sent in response 460 as well as potentially one or more previous scripts prior to modification.

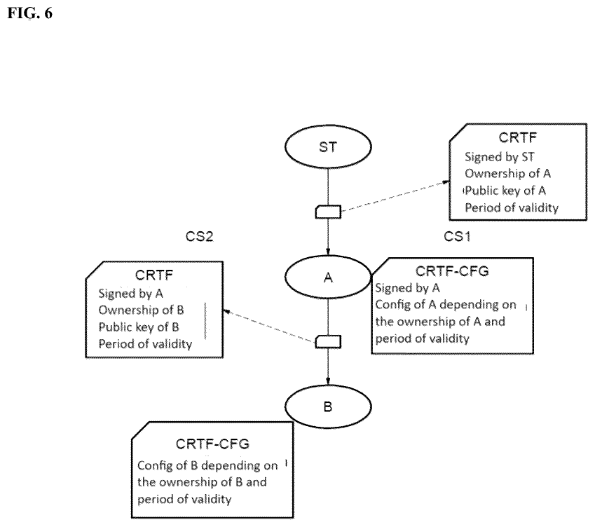

Reference is now made to FIGS. 6 to 9, showing a second embodiment and implementation for communicating the configuration command.

FIG. 6 shows the second embodiment for the method for life cycle management wherein the configuration commands are communicated in the form of certificates CRTF, CRTF-CFG, i.e., commands encoded in a data string with a pre-established structure, possibly in a human-readable manner.

As in the first embodiment described above with reference to FIG. 2, the configuration commands CRTF, CRTF-CFG can include identifying an access right so as to allocate access authorizations to the identified function, or identifying an ownership right so as to allocate the identified function to a new owner.

In this respect, the user A can also provide the user B with the certificate CRTF enabling the ownership of at least one function ISP to be transferred from the user A to the user B such that the new owner B is the sender of the command CRTF without the user A needing to communicate with the system-on-chip.

Here too, the information CRTF is signed by the user A, and includes identifying the at least one function IPS, identifying the user B, for example by communicating a public key of the user B, and optionally a period of validity for this allocation.

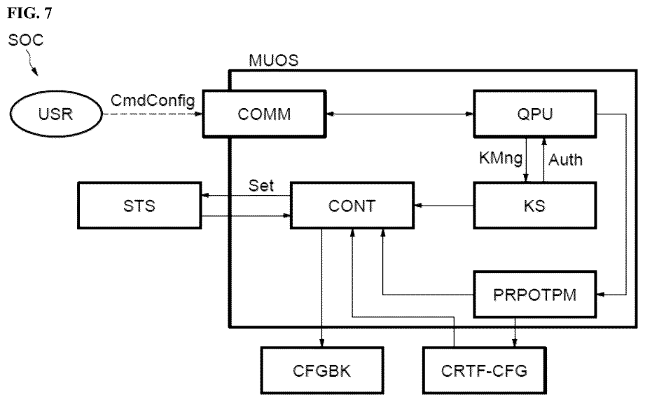

In practice, in the second embodiment, the directory of owners is, for example, contained in a one-time programmable memory PRPOTPM (FIG. 7), i.e., for example a memory in which content can be added, but the existing content cannot be modified. The configuration command is communicated in a certificate CRTF including a data string of the “command word” type, and the certificate CRTF can be stored in the secure memory SECMEM. The ownership management comprises interpreting the certificate CRTF, for example carried out by a control unit CONT, in order to execute the allocation of rights for the identified function IPS, for example by adding an ownership line in the one-time programmable memory PRPOTPM, or by storing access authorizations in the secure memory SECMEM.

FIG. 7 shows an example of the second embodiment of the corresponding ownership management circuit MUOS, i.e., able in particular to process configuration commands communicated in the form of certificates.

As in the first embodiment described above with reference to FIG. 3, the configuration commands CmdConfig are communicated by a user USR via the interface COMM and are processed by the authentication unit QPU, in particular in terms of authentication Auth and management of keys KS, KMng.

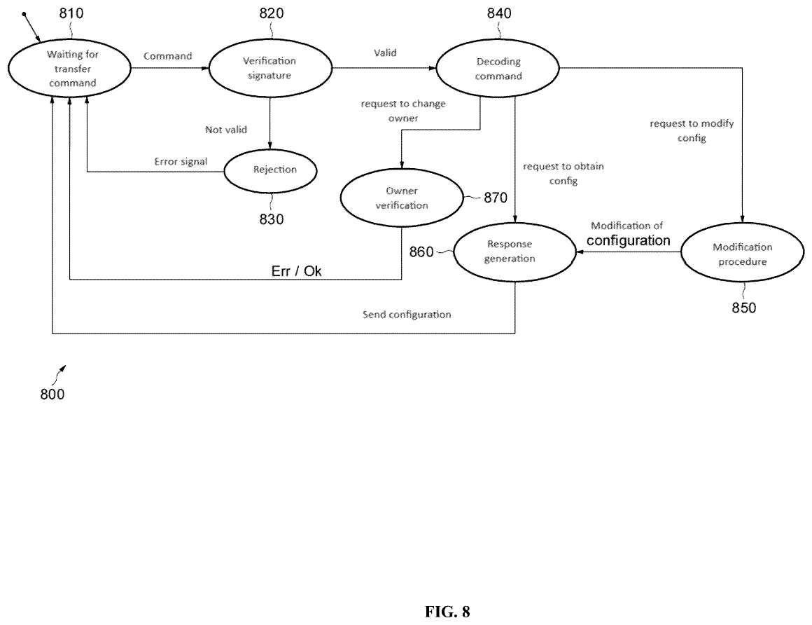

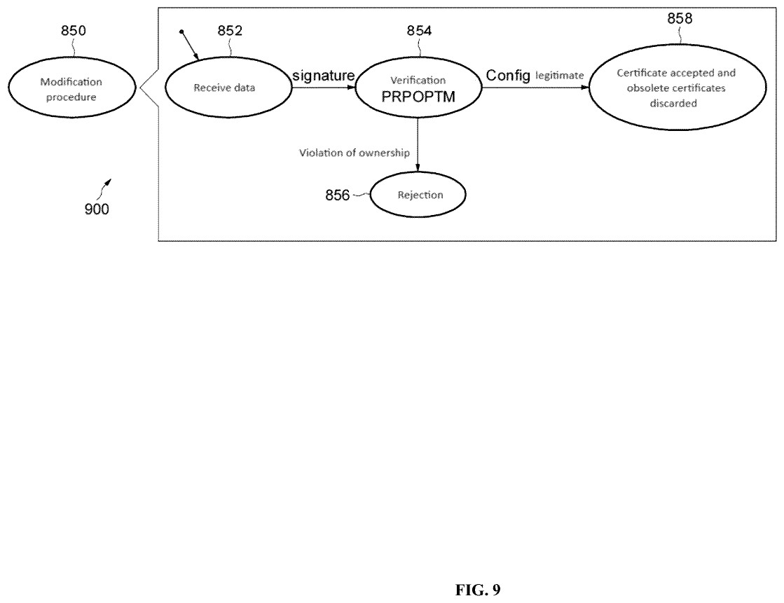

Reference is made to FIGS. 8 and 9 described below concerning carrying out the verification by the authentication unit QPU.

FIG. 8 shows a method 800 similar to the method 400 described above with reference to FIG. 4.

In particular, the method 800 includes an initial state 810 substantially similar to the state 410 of the method 400; a step of verifying the signature 820 and a possible rejection 830, substantially similar to the step 420 and the rejection 430 of the method 400; a step of decoding the command 840 substantially similar to the step 440 of the method 400; a modification procedure of the configuration 850 if modification of the configuration is requested (reference will be made in this regard to FIG. 9), a response containing the current state of the configuration generated in a step 860 substantially similar to the step 460 of the method 400.

In addition, there is a procedure for registering an owner 870 in the directory PRPOTPM in the event that a change of owner is requested. Indeed, the second embodiment and implementation comprise modifying owners internally in the directory stored in the one-time programmable memory PRPOTPM in contrast to the first embodiment and implementation where the directory is communicated in each script.

FIG. 9 shows an exemplary method 900 for implementing the modification procedure of the configuration 850.

The modification procedure of the configuration 850 includes verifying 854 that the owner who signed the received data 852 (the data string encoding the command) does indeed match the last owner of the identified function, according to the contents of the directory PRPOTPM.

If the signature does not match the last known owner, there is a violation of ownership and the request to modify the command configuration is rejected 856.

If the signature does match the last known owner, the received certificate is accepted, and the obsolete parts of the previous certificates are discarded in a memory SECMEM write step 858.

Reference is now made to FIGS. 10 to 14 showing a practical example of the operations of the multi-user ownership management circuit MUOS according to the first embodiment and the second embodiment (the elements only belonging to the second embodiment PRPOTPM, CRTF-CFG are drawn with dashed lines).

For example, in the first embodiment and implementation, the scripts SCRPT are expressed in two parts:
a header defining the ownership, i.e., the directory in which the owners of the functions are listed, and
a function IPS configuration script or “program code”, which, when it is executed by the control circuit CONT, determines the configuration of the features IPS of the system-on-chip SOC.

The header and the program code contain a sequence of instructions, for example usually one instruction per line of script. With each instruction line signed, the control circuit is designed to ensure that at the time of execution each instruction respects the rights of the various users.

For example, a model script with a language adapted to basic configuration commands is shown below. The statements between/* and */are comments explaining the function of the corresponding instruction line.

```
  SCRPT
  SignST> ST OWN IPN /*the user “ST” is the owner of the function IPN*/
  SignST> User OWN IP1, IP2, Ip3/*the user “User” is the owner of the
functions IP1, IP2, IP3*/
  ----
  SignUser> ENABLE IP1, IP3 /*command signed by the user “User” activating
the functions IP1, IP3, i.e., gives the system authorization to access the functions
IP1, IP3*/
  SignUser> FUSE IP1, IP2, IP3 /*command signed by the user “User” making
the configuration of the functions IP1, IP2, IP3 irreversible, i.e., IP1, IP3 activated
and IP2 not activated*/
  SignST> ENABLE IPN for 100 tick /*command signed by the user “ST” activating
the function IPN for 100 cycles of a “tick” signal*/
```

Each instruction line includes:
a signature “SignST>”, “SignUser>”, to prove that the command has actually been added by the owner of the configured function;
the command, such as an activation command “ENABLE”, a deactivation command “DISABLE”, a configuration irreversibility command “FUSE”, an ownership definition command “OWN”;
   the list of functions IPS concerned;
   optionally, an activation/deactivation condition can be added, in particular a time condition “for N tick”.

The time condition will trigger an alarm and will be executed when the continuous timestamp system sends an event. In other words, the allocation of function rights can be programmed at a future time.

For example, in the second embodiment and implementation, the system MUOS for carrying out configuration includes two parts:
the one-time programmable memory PRPOTPM, i.e., the directory in which the owners of the functions are listed, and
the configuration certificates CRFT-CFG, which determine how the functions of the system-on-chip SOC are to be configured for the various users.

Once the certificate has been signed, the control circuit CONT, which is able to execute the configuration in practice, can check the validity of the certificate.

Each certificate CRTF can, for example, have the structure of an instruction line described above, i.e., including:
a signature;
the command;
the list of functions IPS concerned;
optionally, an activation/deactivation condition.

FIG. 10 shows the case of a command to change ownership for the functions IP1, IP2, IP3.

In this example, the manufacturer “ST” initially owns all the functions IP1, IP2, IP3, IPN and transfers part (IP1-3) of them to a user “User”.

In the first embodiment, this is expressed in the script header:

SCRPT
SignST> ST OWN IPN
SignST> User OWN IP1, IP2, IP3

In the second embodiment, this is expressed in the one-time programmable memory:

```
  PRPOTPM
  PKst> ob1111 /*each bit position 1111 respectively matches the functions IPN, IP3,
IP2, IP1*/
  PKuser > obo111 /*the user User is owner of IP3, IP2, IP1, the previous owner “1” of
IPN is unchanged*/
```

The authentication unit QPU registers a new public key of the user “User”, marked PKuser.

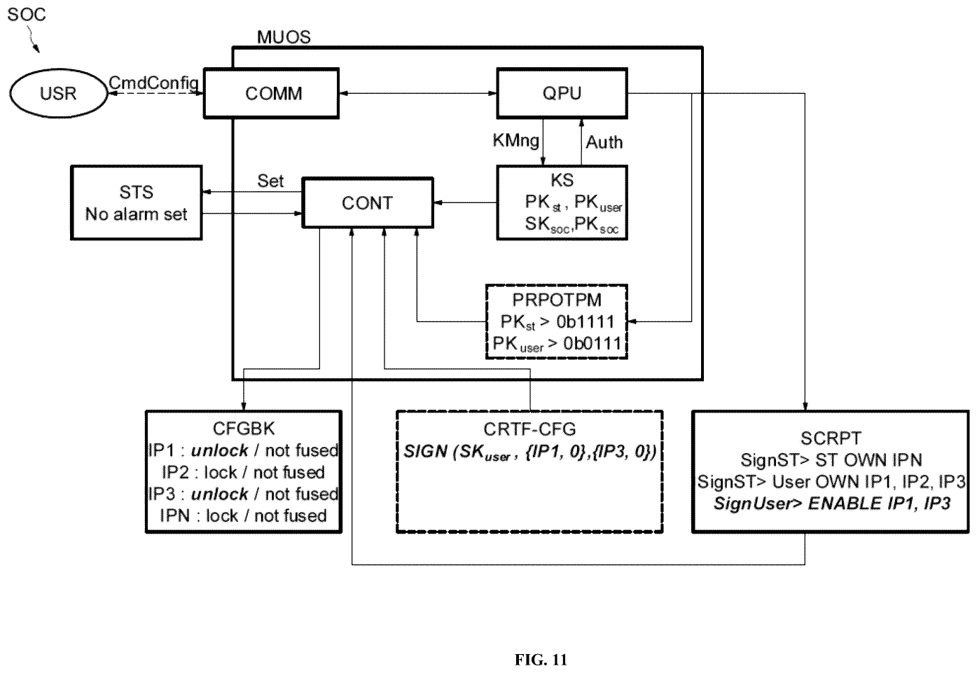

FIG. 11 shows the case of a configuration command, in which the user User activates the functions IP1, IP3.

In the first embodiment, this is expressed in the script SCRPT by the instruction “SignUser>ENABLE IP1, IP3”.

In the second embodiment, this is expressed in the part of the secure memory SECMEM containing the configuration certificates CRTF-CFG:

SIGN (SKuser, {IP1,0}, {IP3,0})/*an example of expression of the corresponding certificate, signed with the secret key SKuser of the user “User” */

This is authorized as the user User is the owner of the functions IP1, IP3 such that access is allocated to the functions IP1, IP3 in the configuration register CFGBK “IP1: unlock”, “IP3: unlock”.

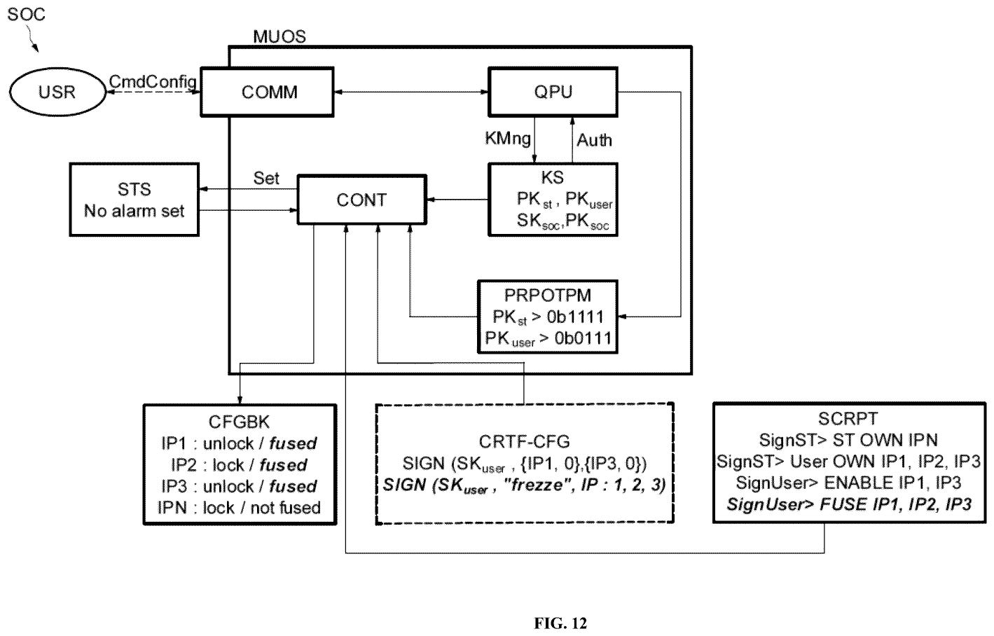

FIG. 12 shows the case of a configuration command, in which the user User wants to make the current configuration of the functions IP1, IP2, IP3 irreversible.

In the first embodiment, this is expressed in the script SCRPT by the instruction “SignUser>FUSE IP1, IP2, IP3”.

In the second embodiment, this is expressed in the configuration certificates CRTF-CFG:

SIGN (SKuser, “freeze”, IP: 1,2,3)/*an example of expression of the corresponding certificate, signed with the secret key SKuser of the user “User” */

This is authorized as the user User is the owner of the functions IP1, IP3 such that access is allocated to the functions IP1, IP3 in the configuration register.

### CFGBK

IP1: unlock/fused

IP2: lock/fused

IP3: unlock/fused

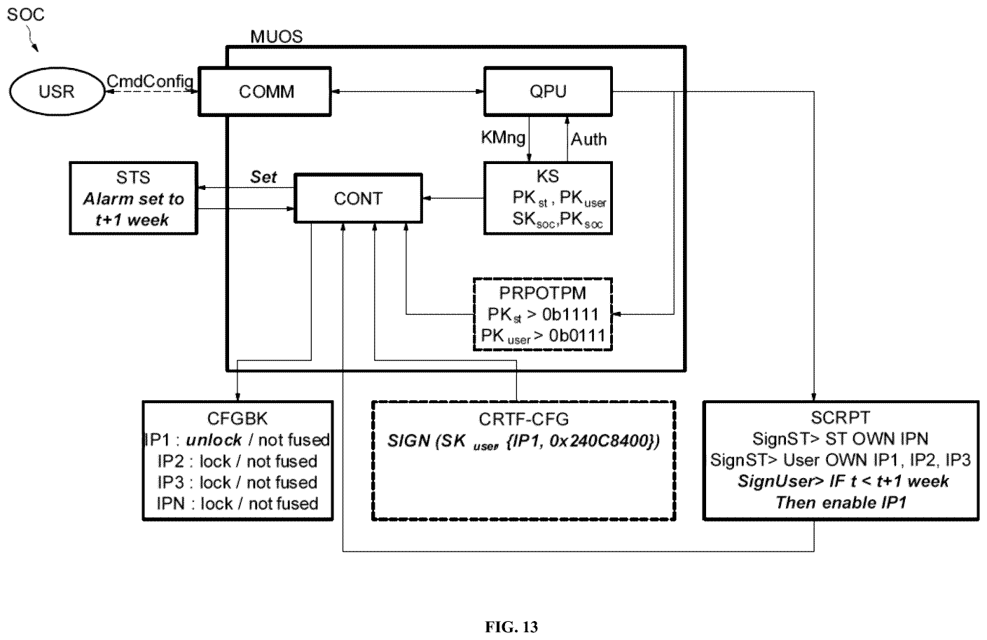

FIG. 13 shows the case of a configuration command, in which the user User activates the function IP1 for a limited time, for example one week.

In the first embodiment, this is expressed in the script SCRPT by the instruction “SignUser>IF t<t+1 week Then enable IP1”.

In the second embodiment, this is expressed in the configuration certificates CRTF-CFG:

SIGN (SKuser, {IP1, ox240C8400})/*an example of expression of the corresponding certificate, signed with the secret key SKuser of the user “User” */

This is authorized as the user User is the owner of the function IP1 such that access is allocated to the function IP1 in the configuration register CFGBK “IP1: unlock”. In addition, an alarm wake-up time is programmed one week after the current time t, “Alarm set to t+1 week”, in the secure continuous timestamp circuit STS.

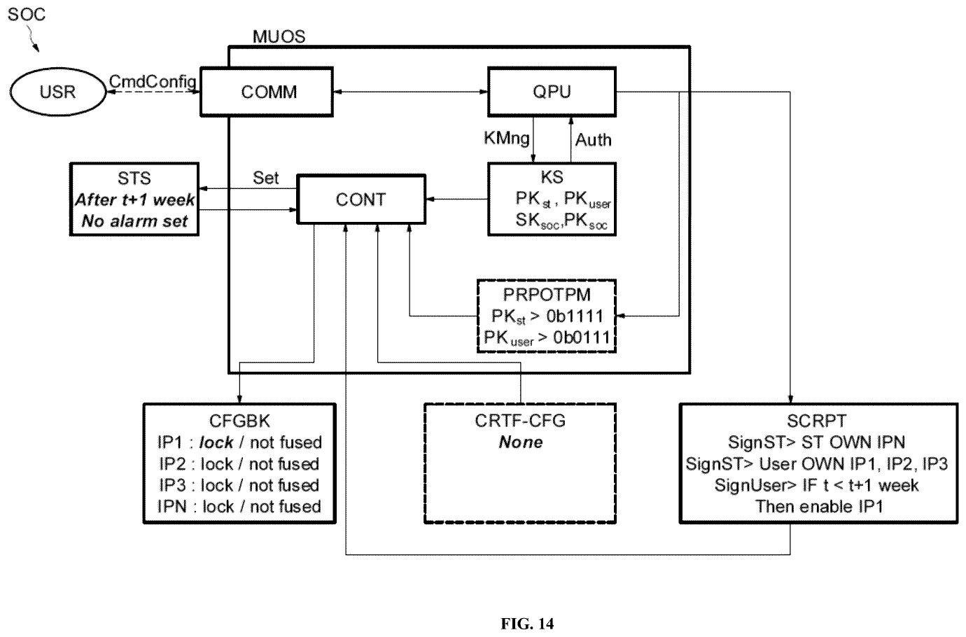

FIG. 14 shows the case of FIG. 13 after the limited activation period for the function IP1 has expired (for example one week later), i.e., when the function IP1 no longer needs to be activated.

At this point, the alarm is generated and is communicated as an interrupt to the control circuit CONT so as to cause a reallocation of access, now unauthorized, to the function IP1 in the configuration register CFGBK “IP1: lock”.

There are no more alarms set in the secure continuous timestamp circuit STS “No alarm set” and the previous configuration certificates CRTF-CFG are deleted from the secure memory SECMEM “None”.

Finally, it should be noted that the examples described above with reference to FIGS. 1 to 14 could be achieved, in whole or in part, in several ways, for example: in a completely hardware configuration, using a “hard-configured” circuit of the state machine type; in a hardware configuration but including a hidden processor configured in software; in a hybrid firmware/hardware configuration of the “secure enclave” type, or in an entirely software configuration, for example in a secure “TEE” (Trusted Execution Environment) processor environment.

In addition, whatever solution is chosen, the implementation of the allocation of function rights for the system-on-chip SOC is advantageously part of the start-up process of the system SOC. In addition, also advantageously, the implementation of the allocation has to be executed to enable access to the protected functions as otherwise the functions are not accessible and only the shared part of the system-on-chip SOC is available.

What is claimed is:

1. A method for life cycle management of a system-on-chip having functions, the method comprising:
managing multi-user ownership, including listing owners of the functions in a directory; and
allocating rights of a function over a life cycle of the system-on-chip, according to a configuration command identifying the function, identifying a right of ownership of or access to the function, and including a signature of an owner of the function.

2. The method according to claim 1, wherein the directory is contained in a programming script stored in a secure memory, the configuration command is communicated in a modified version of the programming script, and the method comprises executing the programming script to carry out the allocating the rights of the identified function.

3. The method according to claim 1, wherein the directory is contained in a one-time programmable memory, the configuration command is communicated in a certificate including a data string and is stored in a secure memory, and the method comprises interpreting the certificate to carry out the allocating the rights of the identified function.

4. The method according to claim 1, wherein the allocating the rights of the function comprises, in response to the configuration command including the identifying the right of access to the function, allocating access authorizations to the identified function.

5. The method according to claim 1, wherein the allocating the rights of the function comprises, in response to the configuration command including the identifying the right of ownership to the function to an identified user, allocating the right of ownership of the identified function to the identified user.

6. The method according to claim 1, wherein the allocating the rights of the function comprises verifying that the signature of the configuration command authenticates a last known owner for the identified function in the directory.

7. The method according to claim 1, wherein the system-on-chip further includes a system authorizing and prohibiting access to the functions according to a content of a configuration register, and the allocating the rights of the function comprises programming the configuration register to allocate the rights of the function.

8. The method according to claim 7, further comprising irreversibly storing the content of the configuration register, in response to the configuration command defining an irreversible nature of the allocating the rights.

9. The method according to claim 7, wherein the allocating the rights of function is performed when the system-on-chip is started up, in cooperation with the system authorizing and prohibiting the access to the functions, such that all access is prohibited prior to the allocating the rights of the function.

10. The method according to claim 1, further comprising continuously generating a timestamp, the allocating the rights of the function comprising programming, at a future time determined by the timestamp, the allocating the rights of the function.

11. The method according to claim 1, wherein the configuration command comprises a transfer of ownership of said function from the owner of the function to an identified user.

12. A system-on-chip, comprising:
functions; and
a life cycle management system incorporating a multi-user ownership management circuit configured to:
list owners of the functions in a directory; and
allocate rights of a function over a life cycle of the system-on-chip, according to a configuration command identifying the function, identifying a right of ownership of or access to the function, and including a signature of an owner of the function.

13. The system-on-chip according to claim 12, wherein the directory is contained in a programming script stored in a secure memory, the configuration command is communicated in a modified version of the programming script, and the ownership management circuit includes a control unit configured to execute the programming script to carry out the allocation of the rights of the identified function.

14. The system-on-chip according to claim 12, wherein the directory is contained in a one-time programmable memory, the configuration command is communicated in a certificate including a data string and is stored in a secure memory, and the ownership management circuit includes a control unit configured to interpret the certificate to carry out the allocation of the rights of the identified function.

15. The system-on-chip according to claim 12, wherein the ownership management circuit is configured to allocate authorizations for the right of access to the identified function, in response to the configuration command including the identifying the right of access.

16. The system-on-chip according to claim 12, wherein the ownership management circuit is configured to allocate right of ownership of the identified function to an identified user, in response to the configuration command including the identifying the right of ownership of the function to the identified user.

17. The system-on-chip according to claim 12, wherein the ownership management circuit includes an authentication unit configured to verify that the signature of the configuration command authenticates a last known owner for the identified function in the directory.

18. The system-on-chip according to claim 12, further comprising a system configured to authorize and prohibit access to the functions of the system-on-chip according to a content of a configuration register, wherein the ownership management circuit is configured to program the configuration register to allocate the rights of the function.

19. The system-on-chip according to claim 18, wherein the configuration register is configured to store the content irreversibly, in response to the configuration command defining an irreversible nature of the allocation of the rights.

20. The system-on-chip according to claim 18, wherein the ownership management circuit is configured to perform the allocation of the rights of the function when the system-on-chip is started up, in cooperation with the system configured to authorize and prohibit the access to the functions of the system-on-chip such that all access is prohibited prior to the allocation.

21. The system-on-chip according to claim 12, further comprising a secure continuous timestamp circuit, wherein the ownership management circuit is configured to program, at a future time determined by the timestamp circuit, the allocation of rights of the function.
